(19) United States
(12) Patent Application Publication
(10) Pub. No.: US 2010/0139361 A1
(43) Pub. Date: Jun. 10, 2010

(54) CALIBRATION ARRANGEMENT FOR AN APPARATUS THAT PREPARES A BEVERAGE FROM WATER AND AN INSTANT PRODUCT

(75) Inventors: Anke Sinnema, Drachten (NL); Peter Sofrides Viet, Drachten (NL); Gertrude Riette Van Der Kamp, Groningen (NL); Matthijs Hendrikus Lubbers, Drachten (NL); Jacqueline Van Driel, Drachten (NL); Roland Van Straaten, Drachten (NL); Simon Martijn Oversteegen, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/513,377

(22) PCT Filed: Nov. 12, 2007
(86) PCT No.: PCT/IB07/54590

§ 371 Date: Dec. 10, 2009

(30) Foreign Application Priority Data
Nov. 14, 2006 (EP) 06124016.4

(51) Int. Cl. G01F 19/00; G06F 19/00

(52) U.S. Cl. 73/1.74; 702/100

(57) ABSTRACT

The invention relates to a calibration arrangement (10) for calibrating an apparatus that is arranged to prepare a beverage from water and an instant product, for different types of instant product. The calibration arrangement comprises: input means (20) for entering a setting into the apparatus, said setting providing the apparatus with dispense information of a particular instant product type, thereby enabling the apparatus to dispense appropriate amounts of said instant product; conversion means (15) for providing the settings for the respective instant product types. The conversion means (15) and the input means (20) function brand independently, that is without making use of or referring to a brand of the instant product type or some other type indication.

### FIELD OF THE INVENTION

The invention relates to a calibration arrangement for calibrating an apparatus that can prepare a beverage from water and an instant product, for different types of instant product.

These apparatuses commonly comprise a reservoir for storing the instant product, a dispenser for dispensing instant product from the reservoir, another dispenser for dispensing water and a controller for controlling the dispensed amounts of instant product and water according to a desired mixing ratio. Such mixing ratio may vary, depending on for example the type of instant product used, or particulars of the intended consumer, such as age and/or weight. Generally, the recommended mixing ratios are expressed in supplier specific quantities, such as a special scoop, supplied together with the instant product. These scoops are dimensioned such that the mixing ratio can be expressed in a number of scoops, for instance one scoop of instant product per every two scoops of water. As a result, the user does not need to perform error sensitive measurements or calculations. It suffices to dose the recommended number of scoops. As every instant product type may feature a different composition, density, specific mass and/or nutritious concentration, the dimensions of the accompanying scoops may differ accordingly. Hence, each supplier has its own scoop, with its own specific dimensions, corresponding to a specific volume or mass of instant product. This volume or mass is often not disclosed in SI units or other common units. Hence, when using an apparatus according to the invention, it needs to be calibrated whenever a different type of instant product is used, in order to teach the apparatus the correct amount of instant product to be dispensed. Several calibration arrangements have been proposed in the prior art.

### BACKGROUND OF THE INVENTION

In US 2005/0178799 for instance, the apparatus manufacturer has determined, for the most popular instant product types available at the market, what amount of instant product corresponds to the supplier specified scoops. This information is pre-programmed into the apparatus. Input means are provided to enter the desired instant product type. Alternatively, the manufacture may provide a chart, listing all the available instant product types, accompanied by an appropriate setting. Said setting can then be entered in the apparatus via input means.

This known calibration arrangement is easy to use and foolproof, provided the user selects the correct product type, respectively setting. However, the user's choice in instant product types is limited to those that have been pre-programmed in the apparatus. When new products enter the market the known calibration arrangement cannot be used, as this new type will neither appear in the apparatus nor on the chart. More worrisome is the situation wherein the composition of an existing instant product type is changed. In such case, the pre-programmed dispense information may no longer be valid yet a user, ignorant of the change, may calibrate the apparatus as usual, resulting in an incorrect amount of instant product to be dispensed.

### SUMMARY OF THE INVENTION

It is an objective of the present invention to provide an apparatus of the above described type with improved calibration means, in which the problems encountered with the prior art calibration means are overcome or at least reduced, while maintaining the advantages thereof. More particularly, it is an objective of the invention to provide the apparatus with calibration means that enable easy, accurate and foolproof calibration for any instant product, including new or renewed instant products.

To that end a calibration arrangement according to the invention comprises conversion means and input means, wherein the input means are arranged to enter a setting into the apparatus, which setting provides the apparatus with the information needed to dispense the correct amount of instant product and the conversion means being arranged to provide the correct setting for a particular type of instant product. The calibration arrangement is characterized in that both the conversion means and the input means function brand independently, i.e. without making use of or referring to the brand or some other name-indication of the instant product.

Instead, the conversion means make use of a measurement tool, which is to be filled with an amount of instant product as prescribed by the supplier, e.g. the contents of one supplier specific scoop or a number of scoops, in accordance with the dosing instructions given by the supplier.

According to one embodiment of the invention, the measurement tool can be calibrated in apparatus compatible units, i.e. volumetric units or weight units that are used by the apparatus when dispensing instant product. In such case, the setting obtained from the measurement tool will be a numeric value, which can be entered in the apparatus via suitably configured input means, such as for example a keyboard. As the entered information represents a supplier specified dosing, expressed in apparatus compatible units, the apparatus thus has all information needed to dispense the correct amount of instant product. With this embodiment, the apparatus does not have to be pre-programmed with any dispense information, as was required with the prior art calibration setups discussed above. Consequently, the calibration arrangement is not limited to existing instant products but can handle every new or modified product type entering the market, provided that its dosing rate falls within the calibration range of the conversion means, i.e. the measurement range of the measurement tool. Furthermore, calibration can be done very accurately, i.e. as accurate as the read out scale of the measurement tool allows.

According to an alternative embodiment, the measurement tool can be calibrated in symbols, such as for instance a letter, a number or a pictogram. Each symbol is linked to a specific dispense value, which has been pre-programmed in the apparatus. The input means may be configured to feature the same symbols as the measurement tool, thereby allowing a user to select the symbol that corresponds to the setting provided by the conversion tool. When a new or modified instant product type enters the market, it suffices to supply the conversion means with an amount of instant product in accordance with the supplier specifications, and to read out the corresponding symbol. Instead of having a user perform this measurement operation with the conversion tool, it can be performed by the supplier of the instant product. The supplier may subsequently communicate this setting to the user, for instance by printing the setting (symbol) on the package, in the instructions, on the scoop or on some other suitable data carrier, such as for instance a barcode, a chip, etc., supplied together with the instant product.

Although the above-described calibration arrangement makes use of pre-programmed dispense values, it can handle all new or modified products that enter the market, without the apparatus having to be reprogrammed, provided that the dispense properties of said new or modified product fall within the range of dispense values that have been pre-programmed in the apparatus. Of course, this range can be chosen as large as believed necessary, even if this means that the symbols representing the lowest and highest dispense quantities will not often be used.

According to an advantageous aspect of the invention, the input means may be provided with reading means, to automatically read out the setting (value or symbol) from said conversion means and enter said setting in the apparatus. This enhances ease of use and may reduce (input) errors, thereby rendering the calibration arrangement substantially foolproof.

In further elaboration, the measuring tool of the conversion means may be formed as a measuring cup. With such measuring cup the apparatus can be readily calibrated in volumetric units thereby allowing the instant product to be dispensed based on volume control. The volumetric dispense characteristics of a dispenser, i.e. the dispensed volume per dispense action, are generally the same for every instant product type. For instance, one revolution of a specific auger will dispense a specific volume of instant product that is substantially the same for every type of instant product. Consequently, once said volumetric dispense characteristics have been determined, it is possible to dispense any desired volume by simply controlling the dispense action, e.g. the number of revolutions of the dispenser. No sensor is needed. Accordingly, the dispense setup can be relatively simple, low cost yet accurate.

The invention furthermore relates to an apparatus for preparing a beverage from water and an instant product, said apparatus being adapted to cooperate with calibration means according to the invention. More particularly, the apparatus may be equipped with suitable input means that are capable of cooperating with conversion means according to the invention.

According to another aspect of the invention, the apparatus may be provided with recognition means for recognizing a receptacle, used to receive the prepared beverage. Such receptacle may for instance be a baby bottle, a tea or coffee cup, a thermos flask, etc. The apparatus can then for instance adjust the position such as for instance the height of the receptacle, or the quantity of beverage to prepare.

The receptacle may be provided with identification means, which may facilitate the recognition process. Said identification means may contain further information on the basis whereof the apparatus can adapt its preparation process.

### BRIEF DESCRIPTION OF THE DRAWINGS

Further advantageous embodiments of a calibration arrangement according to the invention, and an apparatus provided therewith are set forth in the dependent claims and will become clear from the following description in which exemplary embodiments of the invention are described with reference to the accompanying drawings, wherein:

FIG. 1 schematically shows a general set-up of a beverage preparing apparatus according to the invention;

FIGS. 2 and 3 show a set of cooperating calibration means according to the invention, with FIG. 3 representing a conversion tool and FIG. 2 representing conversion input means;

FIGS. 4 and 5 show another set of cooperating calibration means;

FIG. 6 shows an example of a series of receptacles, in particular baby bottles, provided with identification means;

FIG. 7 shows another embodiment of a calibration arrangement according to the invention; and

FIG. 8 shows a graph wherein the dispense rate of an instant product supply unit is plotted against the instant product level in the reservoir of the supply unit.

### DETAILED DESCRIPTION OF EMBODIMENTS

In this description, the invention will be explained in relation to an apparatus for preparing milk, in particular baby milk from water and formula. The invention is however applicable in other appliances for preparing a beverage from a liquid and at least one instant product, such as for instance a medicament(s), a food supplement, vitamins, etc. The instant product may be supplied in various forms, for instance in powder form, ground form or granular form.

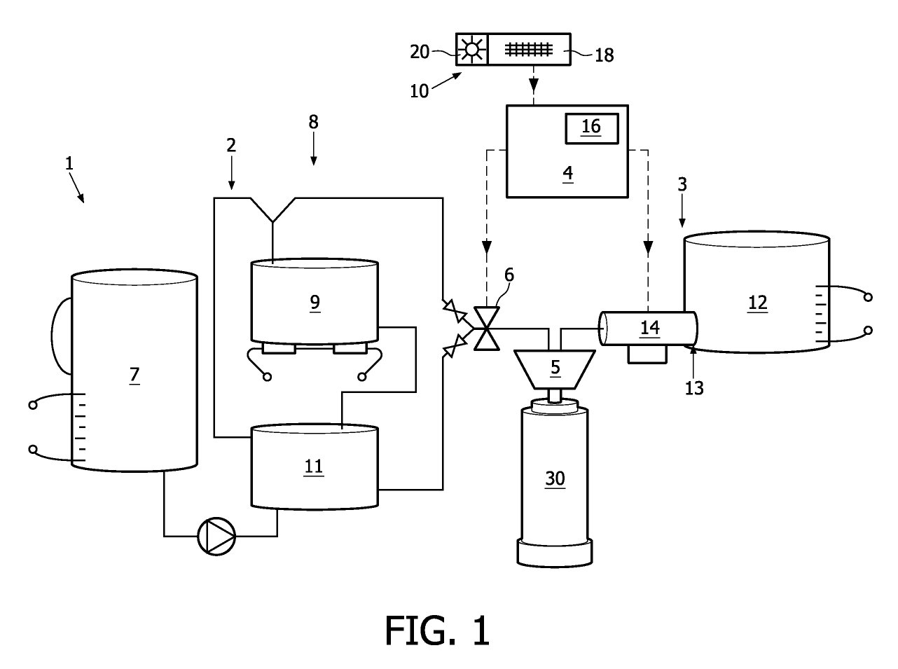

The apparatus 1 according to FIG. 1 comprises a water supply unit 2, a formula supply unit 3, a control unit 4 for controlling the supply of water and formula according to a desired ratio, and a mixing unit 5 for mixing the supplied water and formula.

The water supply unit 2 may comprise a first dispenser 6 for dispensing predetermined amounts of water from a water reservoir 7 or a water main. Furthermore, a treatment section 8 may be provided, for removing or inactivating undesired micro-organisms, such as bacteria. The treatment section 8 may for instance include heating means 9 to sterilize the water, one or more filters, a (UV-) radiation source, an electric pulse generator and/or chemical treatment means. Furthermore, heating and/or cooling means 9,11 may be provided to bring the water at a desired temperature.

The formula supply unit 3 may comprise a reservoir 12 and a second dispenser 14 for dispensing formula from said reservoir 12. Dispense action of the second dispenser 14 may for instance be volume controlled or weight controlled. In the latter case, a weight sensor may be provided to verify the actual dispensed weight. When controlling on volume, the dispensed volume will be substantially the same for every formula, i.e. substantially independent of the formula type. The volume dispensed per dispense action can therefore be determined before use, for one type of formula. Subsequently, the dispensing of all other types can be controlled without the need for a sensor.

The second dispenser 14 can for instance comprise an auger, arranged near an outlet opening 13 of the reservoir 12. The reservoir 12 may be provided with stirring means and/or scraping means (not shown), to supply the auger with a substantially constant feed of formula, as for instance described and shown in the European Patent Application No. 06114225.3 of applicant, titled “Apparatus for preparing baby milk from instant formula”, the contents of which are herein incorporated by reference. Applicant has found that with such setup, the volume dispensed with each auger revolution indeed is substantially similar for every formula type. Thus, the dispensed volume can be controlled by controlling the number of auger revolutions, e.g. by counting said revolutions, for example with an encoder, or by letting the auger rotate during a predetermined time at a predetermined speed. Of course, other dispense configurations are feasible. The second dispenser 14 may for instance comprise a piston or suction means.

The mixing unit 5 may comprise a mixing chamber within the apparatus 1, with suitable mixing means for mixing the water and formula. Alternatively, mixing may be done outside the apparatus 1, for instance in a baby bottle 30.

As such baby bottles 30 or more generally, receptacles for receiving the prepared beverage, come in various shapes and sizes, the apparatus 1 may be provided with recognition means to recognize the various receptacles. Thanks to such recognition means it may for instance be possible to have the apparatus 1 select an appropriate mixing routine and/or mixing means that suit the shape and/or size of the recognized receptacle. Alternatively, the apparatus 1 can verify whether the receptacle 30 in question is large enough for holding the ordered amount of beverage. Also, it is possible to adjust receptacle supporting means, for instance to adjust the position of the receptacle 30. For example, the receptacle 30 may be lowered or lifted to position its fill opening directly under a discharge opening of the apparatus 1.

To facilitate recognition, the bottles 30 may be provided with identification means 32, as shown in FIG. 8. The identification means 32 can be provided on the bottle 30 by the supplier of the bottle, but may alternatively be provided with the apparatus 1, as separate elements, which the user can attach to one or more receptacles of his choice. The identification means 32 may for instance comprise a mark, symbol, relief, bar code, RF tag, chip or the like, and in all cases may contain information regarding the receptacle, such as its size, shape, etc. An example is shown in FIG. 8, wherein the identification means 32 comprise a number of substantially identical notches, provided in the bottom of the receptacle. The number increases with the height of the receptacle, and thus provides information regarding said height.

To help the recognition means in locating the identification means 32, said identification means are preferably provided on a well-defined location. A suitable location is for instance the bottom of the bottle 30, as mentioned before, because no matter what shape or size the bottle has, the bottom will always be easy to localize. Depending on the type of identification means 32, the recognition means may be contact-less or not. The recognition means may for instance comprise optic, electronic and/or magnetic sensors.

It is noted that the above described recognition means and identification means are in their application not limited to apparatuses according to the present invention, but can advantageously be applied in any apparatus in which a receptacle is to be filled with a fluid, in particular apparatuses for preparing baby milk, wherein the receptacle may be a baby bottle.

The control unit 4 may comprise a memory 16 and a suitable user interface 18, such as a key board, touch screen and/or dial, for allowing a user to input and store information regarding for instance the amount of beverage to be prepared, possibly in relation to weight, age and/or feeding scheme of a toddler to be fed, personal preferences of the user such as consumption temperature, ingredients to be used and concentrations thereof, threshold values for triggering safety alarms, calibration support information, etc. This information may be pre-programmed in the apparatus 1 and/or input by a user before a particular session.

The apparatus 1 is furthermore provided with part of a calibration arrangement 10 according to the invention, to enable calibration of the apparatus 1 for different types of formula. The calibration arrangement 10 comprises conversion means 15 for converting formula specific dispense information into apparatus compatible dispense information, and input means 20 for entering said converted information in the apparatus 1. The input means 20 may for instance form part of the user interface 18 of the control unit 4, as shown in FIG. 1.

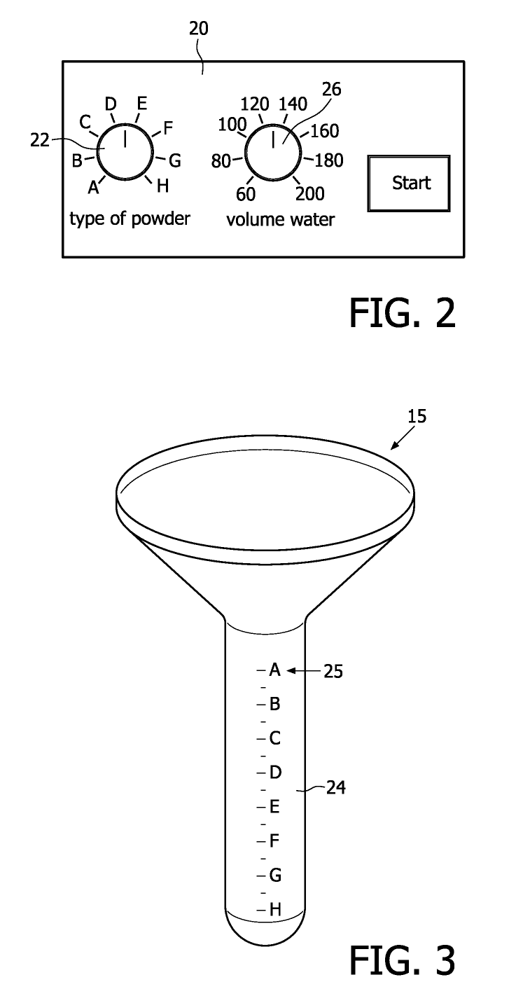

According to one embodiment, the conversion means 15 may comprise a measuring cup 24, as shown in FIG. 3, which may be tubular in shape and preferably comprises a funnel-shaped open end, to facilitate filling. The tubular portion 24 is provided with a graduation 25 of which the individual grades are marked with a symbol, in the given embodiment a letter A-H. Each symbol represents a certain volume that has been pre-programmed in the control unit 4, in apparatus compatible units. The input means 20 comprise a series of user adjustable settings 22, which are marked with the same symbols A-H, as shown in FIG. 2.

Calibration can be carried out as follows. When using a new type of formula, a user is instructed to fill the measurement tool 15 with a certain amount of formula. This amount can be specified as a number of scoops (case 1) or as a number of scoops per specific amount of water, as prescribed by the formula supplier (case 2). In either case, the scoop to be used is the scoop as provided by the formula supplier.

Next, the user is asked to read out the grade A-H that corresponds to the formula level in the conversion means 15, and to input this information in the apparatus 1 by selecting the corresponding setting 22.

In case 1, where the formula amount was specified as a number of scoops, the apparatus 1 then knows the volume of one scoop. To complete the calibration, the mixing ratio needs to be entered. This mixing ratio may for instance be printed at the package of the formula, expressed in scoops (of water and formula). Alternatively, the water amount may be expressed in conventional volumetric units, such as ml. To input this mixing ratio in the apparatus 1, the user interface 18 may be provided with second input means 26, as shown in FIG. 2, of which the selectable settings correspond to pre-programmed mixing ratios. Of course, other embodiments are possible.

In case 2, there are two options to complete the calibration. Either the specific amount of water was prescribed by the apparatus 1, in which case no additional information is needed since the mixing ratio is included in the amount of formula dosed by the user, or the user may have been instructed to dose the formula amount that corresponds to a specific amount of water prescribed on the formula package by the formula supplier. Since the apparatus 1 does not know this specific amount of water, this information needs to be entered, to complete the calibration. Again, suitable second input means may be provided for this purpose.

To increase the accuracy with which the volume of the supplier's scoop can be determined, the user may be instructed to fill the measurement tool 15 with more than one scoop, thereby allowing inaccuracies in for instance dosing or reading out to be averaged out.

To increase the accuracy even further, the user may be instructed to fill the measurement tool 15 with water instead of formula. The flat water level can be read out more accurately than the possibly irregular formula level. It moreover prevents loss of formula and/or contamination of the apparatus 1 due to spilling during calibration.

Instead of having a user fill the measuring cup 24 and read out the level A-H, this measurement can be carried out by the suppliers of the respective formula types. They may then print the relevant setting A-H on the package of the formula, thereby transforming said package into conversion means according to the invention.

Each setting A-H may represent the volume of one scoop of the supplier. This is comparable with case 1 discussed above. To complete calibration, the user must enter the desired mixing ratio in addition to the setting listed on the package. Alternatively, the setting A-H may represent a mixing ratio. To complete calibration, the user then only needs to input the setting A-H. In both cases, involvement of the user is minimized, which allows for a foolproof calibration routine. Also, the setting A-H provided to the user will always be up to date, because as soon as the composition of the formula is changed, the supplier will recalibrate the formula to determine the new setting and adjust the information on the package accordingly.

Of course, the setting information A-H can be applied on other carriers than the package, for instance the scoop, the instructions, or in a bar code, chip, RF tag or the like. In the latter case, the input means may comprise automatic reading means, able to read out said stored setting information. Consequently, calibration can be done almost automatically. The user only needs to hold the scoop or package within reading reach of the reading means.

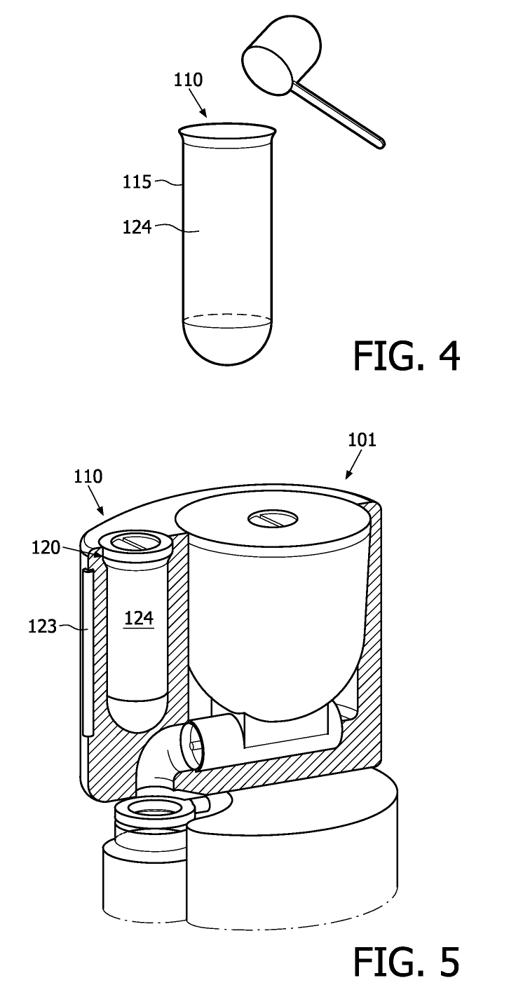

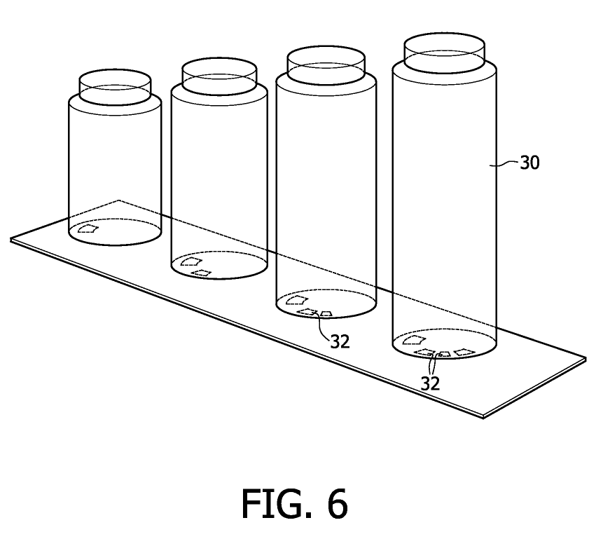

FIGS. 4 and 5 show an alternative calibration arrangement 110 according to the invention. Like components have been denoted with like reference numerals, increased by 100. In this embodiment, the conversion means 115 comprise a measuring tube 124, comparable with the one shown in FIG. 3, but without graduation. The input means 120 comprise a jig for positively mounting the measuring tube 124, and reading means 123 for automatically reading out a filling level of said tube 124 in apparatus compatible volumetric units. The reading means 123 may for instance comprise a height sensor.

The calibration instructions to the user can be similar to those described with reference to the calibration arrangement 10 of FIGS. 2 and 3. That is, the user can be instructed to fill the tube 124 with one or several scoops so that the apparatus 101 can determine the volume of one scoop. To complete the calibration, the user can then enter the desired mixing ratio, expressed in scoops. Alternatively the user may be instructed to fill the tube 124 with an amount of formula that according to the mixing ratio would be needed for a particular amount of water, wherein this amount of water can be specified by the apparatus 101 or by the formula supplier. In the latter case, the user will need to enter this value in the apparatus 101, to allow the mixing ratio to be determined. Of course, to that end, the apparatus 101 may be provided with suitable input means.

FIG. 7 shows an embodiment of an instant product supply unit 203 that can be used in the apparatus of FIG. 1 and a calibration arrangement 210 according to the invention. Like components have been denoted with like reference numerals, increased by 200. The instant product supply unit 203 comprises a reservoir 212 and a dispenser 214 for dispensing a desired amount of instant product from the reservoir. The dispenser 214 may for instance comprise an auger or screw feeder. The calibration arrangement 210 includes conversion means 215, in particular the reservoir 212, and input means 220, in particular a weighing unit 215.

The weighing unit 215 is arranged to measure the weight of the supply unit 203, i.e. reservoir 212 and the dispenser 214. Alternatively, the weighing unit 215 may be arranged to measure the weight of the reservoir 212 only. The weighing unit 215 can comprise any suitable force transducer, such as for instance a load cell. Preferably, the weighing unit 215 is protected from being overcharged. This can for instance be achieved mechanically, by means of a stopper (not shown), that blocks further deformation of the load cell when said deformation has reached a certain limit value.

During use, the weight of the supply unit 203 will change as instant product is added to the reservoir 212 and/or dispensed there from. The weight of the reservoir 212 and dispenser 214 will not change. The weighing unit 215 can be calibrated for this dead weight, so as to only measure weight changes caused by the instant product.

With the above described calibration arrangement 210 the apparatus 1 can be calibrated in two steps. In a first step, the apparatus 1 is informed of the weight of one scoop of instant product. This weight may be specified by the supplier of the instant product. In such case the weight information may be simply entered in the apparatus 1 manually, via for instance the user interface 18. Alternatively, the weight of one scoop may be determined with help of the calibration arrangement 210, by having a user add a scoop of instant product in the reservoir 212. The resulting increase in weight can be measured by the weighing unit 215. To increase accuracy, this calibration step may be repeated twice or more, immediately after one another or at specific time intervals. Alternatively or additionally, the user may be instructed to add several scoops thereby allowing the calibration arrangement 210 to calculate an average scoop weight, which is likely to be more accurate. The number of scoops may be predetermined or may be determined by the calibration arrangement 210 itself. The latter option can be realized as follows. The arrangement 210 may be provided with a counter, that counts the number of scoops by counting the step like increases in weight caused by each scoop. Then, with every scoop, the average weight per scoop is re-computed. Furthermore, the variation around said average weight is computed. Generally this variation will decrease as the number of scoops increases. When this variation drops below a certain pre-set value, the calibration arrangement 210 may instruct the user to stop adding scoops. In this way it is ensured that the first calibration step is performed with a certain level of accuracy.

In a second calibration step, the dispense rate of the dispenser 214 is determined, which may for instance be expressed in a particular dispensed weight per turn (i.e. rotation), if the dispenser 214 comprises an auger or screw feeder. The dispense rate can be determined by having a user fill the reservoir 212 with sufficient instant product. Next, the screw feeder 214 is operated for a specific number of turns, e.g. 30 turns. The weighing unit 215 records the accompanying weight loss of the reservoir 212. With these data the weight per turn can be calculated. Once the weight per scoop (step 1) and the dispense rate of the dispenser 214 (step 2) are known, the number of turns needed for dispensing one scoop can be determined. Of course, if the second dispenser 214 comprises different dispensing means, such as for instance a piston-cylinder or suction means, this second calibration step may be adapted accordingly. In such case, the piston may for instance be displaced over a specific distance, or the suction means may be operated during a specific amount of time. Subsequently, the dispensed amount of instant product can be weighed and correlated to the operation parameter (i.e. piston displacement and operation time respectively).

If desired, the second step can be carried out by the manufacturer of the supply unit 203 or the apparatus 1, for some standard instant product. The outcome of this step (expressed in weight or mass per operation parameter) may then be pre-set in the apparatus 1. As this preset value will be product specific (because dependent on the density of the instant product in question) said setting may not be accurate for every instant product. However, in most instances, it will provide for a reasonable first approximation. By having the weighing unit 215 measure the actual reduction in weight during the first dispensing session, the preset factory setting may be corrected with a more accurate one for the next dispensing session(s). Of course, such correction may take place for every subsequent session, as the density properties of the instant product may slightly change over time, e.g. with the reservoir 212 becoming emptier, or with the humidity in the reservoir 212 changing. For the same reason, such correction may also take place in case where the second calibration step is not factory made but performed at home, at the user's place, in a manner as described before.

Besides accurate calibration, the arrangement 210 according to FIG. 7 provides several other advantages. For one, with this arrangement 210 it is possible to verify what amount of instant product has been actually dispensed. This may be of considerable importance in case where the beverage is meant to possess a certain nutritious value or to possess a certain amount of medicament. If the actual dispensed value deviates from a target value, the user may be informed. In addition (or alternatively) the amount to be dispensed for the subsequent session may be adjusted, so as to compensate for the previous overdoses or under doses.

Furthermore, the weighing unit 215 may be arranged to monitor the dispensed amount of instant product in a continuous way, thereby allowing the dispenser 214 to be controlled via a feedback control loop, to dispense the desired amount of instant product.

Alternatively, the weighing unit 215 may be arranged to measure the dispensed amount at discrete time intervals, in particular by measuring the reservoir weight just before a dispensing session and just there after, that is, when the dispenser 214 is at rest. Such way of measuring provides the advantage that the measurements will not be disturbed by dynamics of the dispenser 214 and hence can be very accurate. These measurement data can then for instance be used to correct the settings of the dispenser 214 for the next dispensing session, via a feed forward control loop.

According to a preferred embodiment, the measured dispense data can be stored, and evaluated to identify trends. From these data it may for instance be found that the dispensed weight or mass per turn of the screw feeder 214 varies with the level of instant product in the reservoir 212, as shown in FIG. 8. This information can then be used to predict the number of screw feeder turns needed to have the dispenser 214 dispense the desired amount of instant product. Thus the measured data can serve as learning curve for feed forward control of the dispenser 214. To prevent that one dispensing error affects all subsequent dispense actions, a filter or damping mechanism may be included, which may for instance ensure that he number of screw turns between subsequent dispense sessions may not differ from each other by more than two screw turns.

The weighing unit 215 can furthermore signal when the reservoir 212 is almost empty, i.e. when the instant product weight drops below a certain minimum threshold value. The unit 215 may then instruct the user to refill the apparatus 1. No separate level indicator is needed. The minimum threshold value may be set taking into account several influences. For instance, from the aforementioned trends (as shown in FIG. 8) it may be determined what minimum content level is needed to have the dispenser 214 function properly, for instance ten percent of the maximum content level. This minimum content level may then be augmented with the amount of instant product needed for preparing the largest serving the apparatus 1 is capable of preparing. Alternatively, the apparatus 1 may check how much beverage a user desires to prepare, calculate how much instant product will be needed to do so, and verify whether such amount is present in addition to said minimum content level. If the actual content level is lower than the required level, the user may be instructed to refill the reservoir 212 and the beverage preparing process may be interrupted until the reservoir 212 has actually been refilled.

The respective calibration arrangements, as described above, each provide at least one of the following advantages:

calibration can be based on volume. Consequently, dispensing of formula can be based on volume as well, offering the advantage that no sensor is needed;

calibration can make use of pre-programmed information, which is linked to brand independent settings in such way that the composition and dispense characteristics of the various formula types may change, without the pre-programmed information having to change;

calibration can be done foolproof, or at least without error sensitive calculations on the user side. At most a user is required to perform an operation he would have to do anyway, when preparing the beverage without apparatus;

calibration can be done accurately. The operations that are to be performed by the user can have increased accuracy by using water instead of formula and/or by letting the user dose a plurality of scoops instead of one, so that accidental inaccuracies can be averaged out.

The invention is not in any way limited to the exemplary embodiments presented in the description and drawing. All combinations (of parts) of the embodiments shown and described are explicitly understood to be incorporated within this description and are explicitly understood to fall within the scope of the invention. Moreover, many variations are possible within the scope of the invention, as outlined by the claims.

1. Calibration arrangement (10, 110) for calibrating an apparatus (1) that is arranged to prepare a beverage from water and an instant product, for different types of instant product, said calibration arrangement (10, 110) comprising:
input means (20, 120) for entering a setting into the apparatus, said setting providing the apparatus (1) with dispense information of a particular instant product type, thereby enabling the apparatus (1) to dispense appropriate amounts of said instant product;
conversion means (15, 115) for providing the settings for the respective instant product types;
characterized in that the conversion means (12, 115) and the input means (20, 120) function brand independently, that is without making use of or referring to a brand of the instant product type or some other type indication.

2. Calibration arrangement according to claim 1, wherein the settings are represented by respective symbols, each symbol corresponding to a specific dispense quantity, that has been pre-programmed in the apparatus in apparatus compatible dispense units.

3. Calibration arrangement according to claim 1, wherein the conversion means comprise a measuring cup, calibrated in apparatus compatible dispense units.

4. Calibration arrangement according to claim 1 wherein the conversion means comprises a measuring cup, of which the graduation corresponds to the respective settings.

5. Calibration arrangement according to claim 1, wherein the conversion means comprise a data carrier, such as for instance a package, manual, dosing tool, chip, a barcode, a RF tag or some other paraphernalia supplied together with the instant product, wherein said data carrier is provided with the appropriate setting for said instant product.

6. Calibration arrangement according to claim 1, wherein the input means comprise reading means for automatically reading out a setting from the conversion means.

7. Calibration arrangement according to claim 1, wherein the dispense information provided by the settings is expressed in volumetric units, so as to enable volume controlled dispensing.

8. Calibration arrangement according to claim 1 wherein the conversion means comprise an instant product reservoir and the input means comprise a weighing unit, which is arranged to measure variations in the weight of said reservoir, caused by instant product being added thereto or dispensed there from.

9. Calibration arrangement according to claim 8, wherein the input means furthermore comprise signal processing means for identifying step like changes, in particular step like increases in the measured reservoir weight and means for counting said step like changes.

10. Calibration arrangement according to claim 9, wherein the arrangement comprises computation means for computing an average weight change for every step like weight change, as well as a variation around said average weight change, and wherein the arrangement furthermore comprises a comparator for comparing these computed variations with a threshold value.

11. Calibration arrangement according to claim 8, wherein the weighing unit is arranged to measure the reservoir weight continuously and wherein said measured data are used in a feedback control loop to control a dispenser into dispensing a desired amount of instant product from said reservoir.

12. Calibration arrangement according to claim 8, wherein the weighing unit is arranged to measure the reservoir weight just before and after instant product has been dispensed there from, when dispensing means are at rest, to measure the actual dispensed amount of instant product, and wherein said measured data are used in a subsequent dispensing session, to have a dispenser dispense a desired amount of instant product from the reservoir.

13. Calibration arrangement according to claim 8, wherein the arrangement is arranged to signal a user when a content level in the reservoir drops below a predetermined value.

14. Apparatus for preparing a beverage from water and an instant product, the apparatus comprising a dispense unit that comprises a reservoir and a dispenser for dispensing instant product from said reservoir, and input means that have the features of input means according to claim 1 and are arranged to cooperate with conversion means according to claim 1.

15. Apparatus according to claim 14, wherein the apparatus comprises recognition means for recognizing a receptacle intended to receive the prepared beverage, such as a baby bottle.

16. Apparatus according to claim 15, wherein the recognition means are designed to recognize the receptacle on the basis of identification means provided on the receptacle.

17. Apparatus according to claim 16, wherein the identification means contain information regarding the receptacle and the recognition means are arranged to read such information.
